(19) United States
(12) Patent Application Publication
(10) Pub. No.: US 2015/0100355 A1
(43) Pub. Date: Apr. 9, 2015

(54) METHOD AND APPARATUS FOR IDENTIFYING EARLY STATUS

(71) Applicant: HITACHI, LTD., Tokyo (JP)

(72) Inventors: Kouichi TANIMOTO, Tokyo (JP); Junji OGASAWARA, Tokyo (JP); Masayoshi YOSHIMOTO, Tokyo (JP); Osamu IMAICHI, Tokyo (JP)

(21) Appl. No.: 14/503,502

(22) Filed: Oct. 1, 2014

(30) Foreign Application Priority Data
Oct. 3, 2013 (JP) 2013-208222

(51) Int. Cl. G06Q 50/26; G06Q 10/06

(52) U.S. Cl. CPC G06Q 50/26; G06Q 10/063
USPC 705/7.11

(57) ABSTRACT

To support rapid and effective information collection, analysis, and status identification, an apparatus for identifying early status includes a data collection unit for collecting and classifying information, an intelligence deriving unit for analyzing collected and classified data, and an information display unit for displaying the collected, classified, and analyzed data. The data collection unit collects information transmitted by an information transmitter from a terminal device, summarizes the content included in the information, and registers the information with the summary in a database. The intelligence deriving unit calculates the reliability by analyzing the information transmitter and the content of the information, and registers the information with the reliability in a database. The information display unit replaces the summary of the information registered in the database with corresponding icon, displays the results, and displays the information according to the reliability of the information, with respect to the information registered in the database.

### CLAIM OF PRIORITY

The present application claims priority from Japanese application serial no. JP2013-208222, filed on Oct. 3, 2013, the content of which is hereby incorporated by reference into this application.

### BACKGROUND

The present invention relates to decision making support techniques, and more particularly, to techniques for collecting, managing, and providing information to identify the status quickly and effectively and to take measures according to the status.

It is important to recognize an event occurred and the associated status to respond to the event. For example, when a disaster occurs, organizations such as national government and local public entities must quickly and effectively identify the damage status to implement disaster response activities (such as rescue of victims, infrastructure recovery, and evacuation guidance), in order to take measures according to the status.

As a technique for supporting identification of the status, Japanese Unexamined Patent Application Publication No. 2011-248708 discloses a method for visualizing the status by displaying collected information on a geographic space. Further, as a technique for analyzing collected information, Japanese Unexamined Patent Application Publication No. 2012-65054 discloses a method for obtaining and analyzing trend information that is the information on the trend in the Internet, and extracting the status in the world from the analysis results.

### SUMMARY

However, Japanese Unexamined Patent Application Publication No. 2011-248708 mainly describes the visualization of the collected information on the map, and does not disclose a method capable of addressing the difficulty in collecting information and of identifying the status more quickly. In particular, in an emergency such as a disaster in which the report information itself is not sufficient, it is difficult to provide quick and effective status identification.

Further, Japanese Unexamined Patent Application Publication No. 2012-65054 describes a method for analyzing and identifying the trend status by the information on the Internet, but does not disclose a method for flexibly changing the collection purpose and methods. Thus, it is difficult to quickly and effectively collect and analyze information, during an emergency with a lot of unexpected situations in which an event that occurs, the progress status, the information that can be collected, and the content of the measures are unpredictable. Further, in the use of the information on the Internet, in particular, burying critical information caused by the mixture of false information as well as a huge amount of information may constitute an obstacle to quick identification of the status, in particular, in the confusion of the emergency. In addition, it is necessary to improve the amount and quality of the information to be collected by feeding back the information analysis results to the information collection and delivery.

In order to solve the above problems, the present invention provides a method for identifying early status performed by an apparatus for identifying early status to collect, classify, and register information of an event occurred, through a network. The method for identifying early status includes the steps of: collecting information transmitted from a terminal device by an information transmitter; summarizing the content included in the information; adding the summary to the information and registering in a database; calculating the reliability of the collected information by analyzing the information transmitter and the content of the information; when a critical event has occurred, increasing the use of information with relatively low reliability and displaying the information to the user; instructing an on-site user present in an area showing information vacuum, to collect information on the information vacuum area; and repeating the collection, classification, analysis, and display of the information reported by the on-site user, as well as the instruction to collect information in order to increase the reliability of the displayed information.

Further, in order to solve the above problems, according to the present invention, items for which the content included in the collected information is summarized include at least acquisition time, transmitter, position information, classification tag, link destination to an image or video, and reliability.

Further, in order to solve the above problems, according to the present invention, the apparatus for identifying early status is connected to a service user terminal and an on-site user terminal to use the functions and information of the apparatus through the network as services. The apparatus is also connected to a service provider terminal for providing information to the service user by operating the apparatus. Upon access from the service user terminal, the apparatus for identifying early status authenticates the user to start the service, based on the registration information. The apparatus for identifying early status receives requests for collection, classification, analysis, and search from the service user terminal, and provides various screen data based on the collected and classified data. Further, the apparatus receives a request from the service user terminal to deliver an instruction to the on-site user terminal, and delivers the instruction information to the on-site user terminal to collect on-site information.

Further, in order to solve the above problems, according to the present invention, the apparatus for identifying early status includes: a data collection unit for collecting information on an event occurred through a network, adding a classification tag from a keyword included in the collected data based on a classification rule, and registering the information with the classification tag in a collection classification database; an intelligence deriving unit for monitoring and extracting an event or area in which the amount of data quickly increases, emerges, or decreases, or an area in which the amount of collected data is small or large as compared to population distribution data included in the map data and to the hazard map, and an event or area in which the difference in the amount of data is large as compared to the data stored in the past disasters, based on an analysis rule with respect to the data stored in the collection classification database, and storing the results in an analysis result database; an information display unit for mapping the data stored in the collection classification database and the analysis result database, on the map data based on the position information, and for displaying the results through a user interface; an information delivery unit for converting the data stored in the collection classification database and the analysis result database into a format that can be displayed and used in a user terminal and the like, and for delivering the results to the user terminal and the like; and a rule management unit for generating the data collection rule, a classification rule describing the relationship between the collected data and the classification tag to be added, and an analysis rule describing the analysis algorithm, based on the input of the user, and updating the collection rule, the classification rule, and the analysis rule, based on the data stored in the collection classification database and the analysis result database automatically or updating the rules based on the input of the user.

According to the present invention, the following effects can be obtained.

A responder to an event, such as a disaster, can effectively identify the status by quickly and continuously collecting information on an event that occurred or may occur, while minimizing the influence of incorrect or false information and ensuring the information search capability, even under conditions in which unexpected event may occur.

Further, it is possible to provide take measures according to the status and to collect more variable information by using the information presented for the identification of the status.

### BRIEF DESCRIPTION OF THE DRAWINGS

FIG. 1 is an example of a block diagram of an apparatus for identifying early status;

FIG. 2 is an example of a view of an information processing flow;

FIG. 3 is an example of a view of a status monitoring/identification flow;

FIG. 4 is an example of a block diagram of a collection classification database and an analysis result database;

FIG. 5 is an example of a view of an information analysis flow;

FIG. 6 is an example of a view of an instruction delivery flow;

FIG. 7 is an example of a view of an information improvement flow;

FIG. 8 is an example of a view of a damage identification screen;

FIG. 9 is an example of a view of an analysis result display screen;

FIG. 10 is an example of a view of an instruction delivery screen;

FIG. 11 is an example of a view of a screen when the information processing flow is performed; and

FIG. 12 is an example of a view of a service form using the apparatus for identifying early status.

### DETAILED DESCRIPTION

Hereinafter, preferred embodiments of the present invention will be described with reference to the accompanying drawings. The embodiments will be described by citing an apparatus for supporting information collection when a disaster occurs, and an apparatus for supporting status identification by the information collected by the apparatus for supporting information collection. However, the present invention can be applied to other fields.

### First Embodiment

In this embodiment, the description will be made for the case in which a disaster response is carried out by using an apparatus 101 for identifying early status.

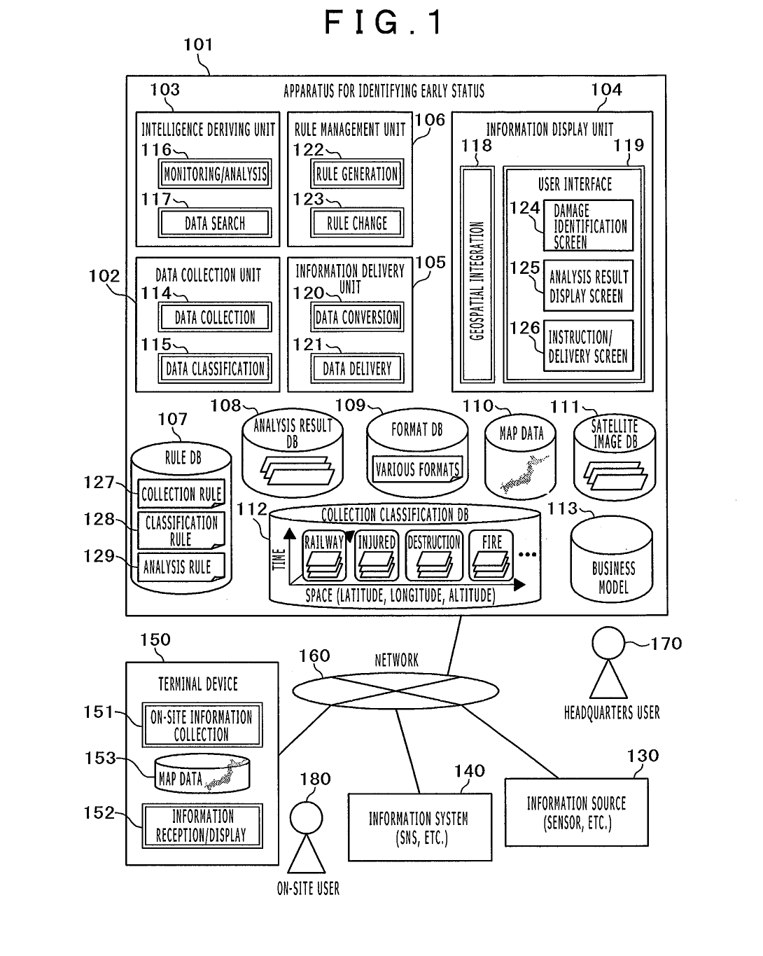

FIG. 1 is a block diagram of an example of the system configuration of the apparatus 101 for identifying early status according to the present embodiment, in which each user terminal 150 is connected through a network 160. As shown in the figure, the system for identifying early status according to the present embodiment is a system that collects and manages information on a disaster, to use the information in a disaster response. The system includes: the apparatus 101 for identifying early status for collecting disaster information through a network 160 such as the Internet, classifying and analyzing the collected information to be able to contribute to the recognition of the status, and providing effective information to allow, for example, a headquarters user 170 who heads the disaster response, to identify the status quickly and effectively and to take measures according to the status; an information source 130 such as a sensor for providing information to the apparatus 101 for identifying early status, and a disaster prevention system that the disaster management organization has; an information system 140 for providing social network service (hereinafter, referred to as SNS) and the like; and a terminal device 150 through which an on-site user 180 collects on-site information based on an instruction from the headquarters user 170 or based on the information provided by the apparatus 101 for identifying early status, to provide information to the apparatus 101 for identifying early status directly through the network 160 or by using the information system 140.

Multiple information sources 140, information systems 140, and terminal devices 150 may be present in the system. Further, the headquarters user 170 or the on-site user 180 may use both the apparatus 101 for identifying early status and the terminal device 150. Note that the various types of information are transmitted and received through the network 160, including text information, position information, time information, voice information, images, video, or other information on the transmitter.

The apparatus 101 for identifying early status may be placed in the building, server room, and the like of the organization to which the headquarters user 170 and the on-site user 180 belong. It is also possible to place the apparatus 101 for identifying early status in a data center physically distant from the organization.

Further, a typical software configuration in the apparatus 101 for identifying early status and the terminal device 150 will be described in detail with reference to FIG. 1.

The apparatus 101 for identifying early status includes a data collection unit 102, an intelligence deriving unit 103, an information display unit 104, an information delivery unit 105, a rule management unit 106, a rule DB (database) 107, an analysis result DB 108, a format DB 109, a map data 110, a satellite image DB 111, a collection classification DB 112, and a business model 113.

The data collection unit 102 includes: a data collection function 114 for collecting information based on a collection rule 127 stored in the rule DB 107 from the information source 130, such as sensor devices such as seismographs and river level indicators, the information media such as news reports and the Internet, and a disaster prevention system that each disaster management organization has, and from the information system 140 for providing SNS and the like, as well as the terminal device 150 and the like; and a data classification function 115 for classifying the information collected by the data collection function 114 based on the classification rule 128 stored in the rule DB 107, and storing in the collection classification DB 121, together with information such as the collection time and collection area of each data. Here, the collection rule 127 describes the information required for the data collection function, such as collection frequency, collection area, and collection keyword. The collection rule 128 describes the rule to classify the collected information into events such as fire, tsunami, and building damage. For example, when keywords related to fire such as “smoke” and “flame” are included in the collected information, it is classified into the information related to “fire” (keywords such as “fire” are hereinafter referred to as the classification tags). The classification tags, such as “earthquake”, “fire”, “tsunami”, “traffic”, and “evacuation” may be registered in the classification rule in advance. It is also possible to add, modify, and delete classification tags during the operation.

The intelligence deriving unit 103 includes a monitoring/analysis function 116 for monitoring and extracting an event or area in which the amount of data quickly increases, emerges, or decreases, or an area in which the amount of the collected data is small or large as compared to the population distribution data included in the map data 110, the hazard map, and the like, or an event or area in which the difference in the amount of data is large as compared to the data stored in the past disasters, based on the analysis rule 129 stored in the rule DB 107, with respect to the data stored in the collection classification DB 112, to store the results in an analysis result DB 108. Further, the intelligence deriving unit 103 also includes a data search function 117 for searching the collection classification DB 112 and the analysis result DB 108 for data that the headquarters user 170 requires, or automatically searching for data based on the business flow stored in the business model 113, to provide the results to the information display unit 104. Here, the hazard map shows the damage prediction in each area during a disaster, before or after the event by simulation or other methods. Further, the business model 113 includes classification tags related to the various operation flows such as evacuation call, shelter management, rescue supply delivery, and emergency life-saving operations. For example, classification tags such as “traffic” and “evacuation” are associated with the evacuation call operation.

The information display unit 104 includes a geospatial integration function 118 for mapping data stored in the collection classification DB 112 and the analysis result DB 108 or data provided from the data search function 117, to the map data included in the map data 110 and the satellite image data included in the satellite image DB 111 (in other words, to match the provided data to the position on the map data or the image data), based on the information showing the geographical position such as latitude, longitude, and altitude. Further, the information display unit 104 also includes a user interface 119 for displaying a damage identification screen 124, an analysis result display screen 125, and an instruction/delivery screen 126 with respect to the data stored in the collection classification DB 112 and the analysis result DB 108, based on the information such as the time included in each data and based on the information mapped to the map data and the satellite image data by the geospatial integration function 118, and for receiving an input from the headquarters user 170.

The information delivery unit 105 includes a data conversion function 120 for converting the data stored in the collection classification DB 112 and the analysis result DB 108 into a data format that can be displayed and used in the information system 140, which provides a disaster prevention system owned by each disaster management organization, SNS, and the like, as well as used in the terminal device 150, based on different formats stored in the format DB 109. Further, the information delivery unit 105 also includes a data delivery function 121 for transmitting data to the information system 140, which provides a disaster prevention system owned by each disaster management organization, SNS, and the like, with respect to the data stored in the collection classification DB 112 and the analysis result DB 108, or with respect to the data converted by the data conversion function 120, based on an instruction input from the instruction/delivery screen 126 of the user interface 119, or at regular intervals, or at a time of change in the data stored in the collection classification DB 112 and the analysis result DB 108.

The rule management unit 106 includes a rule generation function 122 for generating the collection rule 127 describing data collection destination, collection frequency, collection keywords or other information used in the data collection unit 102, the classification rule 128 describing the relationship between the collected data and the classification tag to be added, and the analysis rule 129 describing the analysis algorithm used in the intelligence deriving unit 103, based on the input of the headquarters user 170, to store in the rule DB 107. Further, the rule management unit 106 also includes a rule change function 123 for automatically updating the collection rule 127, the classification rule 128, and the analysis rule 129, based on the data stored in the collection classification DB 112 and the analysis result DB 108, or updating the rules based on the input of the headquarters user 170.

The terminal device 150 includes an on-site information collection function 151 by which the on-site user 180 can input information through the network 160 and transmit the information directly to the apparatus 101 for identifying early status, or through the information system 140 which provides SNS, and the like. Further, the terminal device 150 also includes an information reception/display function 152 for displaying data received from the apparatus 101 for identifying early status, or displaying map data 153 at the same time.

Information processed in the apparatus 101 for identifying early status, as well as information transmitted from the information source 130, the information system 140, and the terminal device 150 are text information, position information, time information, voice information, images, video, or other information on the transmitter. Here, the position information is obtained, for example, from GPS or by using the position information such as the base station of mobile phone to be used.

The apparatus 101 for identifying early status continuously collects and monitors information on a regular basis, to provide the abnormality detection immediately after the occurrence of a critical event such as a disaster, as well as the progress of the status to the headquarters user 170 by the collected data. Then, the apparatus 101 for identifying early status repeats the information collection based on the instruction from the headquarters user 170 or automatically, to increase the amount and quality (reliability) of the information contributing to the management instructions of the headquarters user 170, and provide the information capable of contributing to the management measures. The following will describe the information processing flow for increasing the amount and quality of information in the apparatus 101 for identifying early status, and providing the information capable of contributing to the management measures.

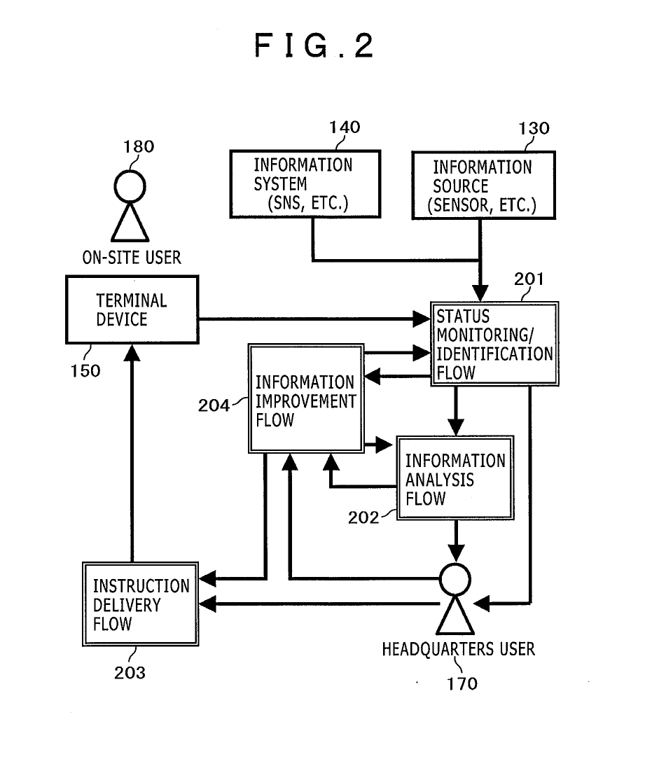

FIG. 2 is a view of the information processing flow in the present embodiment.

The information processing flow according to the present invention mainly includes a status monitoring/identification flow 201, an information analysis flow 202, an information delivery flow 203, and an information improvement flow 204.

The status monitoring/identification flow 201 collects information from the information source 130, the information system 140, and the terminal device 150. Then, the status monitoring/identification flow 201 stores the collected information in the information collection DB 112 or provides to the headquarters user 170.

The information analysis flow 202 analyzes the information based on the data that is processed by the status monitoring/identification flow 201 and stored in the collection classification DB 112. Then, the information analysis flow 202 stores the results in the analysis result DB 108 or provides to the headquarters user 170.

The instruction delivery flow 203 delivers the information to the terminal device 150, based on the input from the headquarters user 170 or based on the data received from the information improvement flow 204.

The information improvement flow 204 updates the rule DB 107 based on the data that is processed by the status monitoring/identification flow 201 and stored in the collection classification DB 112, or based on the data stored in the analysis result DB by the information analysis flow 202, or based on the input from the headquarters user 170. Further, based on the rule DB 107 updated by the information improvement flow 204, the status monitoring/identification flow 201 and the information analysis flow 202 are performed.

With the information processing flow according to the present invention, the apparatus 101 for identifying early status provides information for identifying and analyzing the damage status, and the like, to the headquarters user 170, by increasing the use of the information with relatively low reliability delivered from common residents during the time when the amount of collectable information is small just after the disaster occurred. Then, the apparatus 101 for identifying early status continuously performs the information processing flow to gradually increase the reliability of the information to identify and analyze the disaster status more accurately, in order to provide information capable of contributing to the accurate determination and management measures of the headquarters user 170. In this way, it is possible to quickly and continuously make decisions regarding determination and management measures, under critical conditions such as the occurrence of unexpected events, for example, in the case of insufficiency of the information from the sensors, information systems, and disaster management organizations, which are initially expected to be the information sources.

Hereinafter, the status monitoring/identification flow 201, the information analysis flow 202, the information delivery flow 203, and the information improvement flow 204 will be described in detail with reference to the drawings.

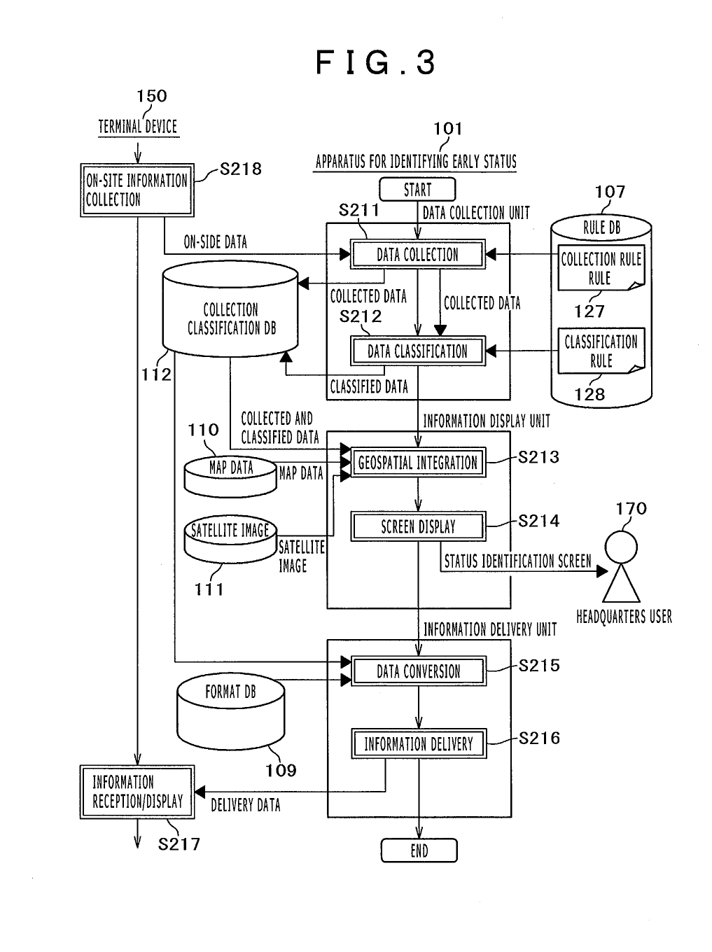

FIG. 3 schematically shows the status monitoring/identification flow according to the present embodiment.

The apparatus 101 for identifying early status uses the data collection function 114 to collect information from the information source 130 such as the sensor device like seismographs and river level indicators, the information media such as news reports and the Internet, and a disaster prevention system that each disaster management organization has, and from the information system 140 for providing SNS and the like, as well as the terminal device 150 and the like, based on the collection frequency, collection area, and collection keyword described in the collection rule 127 stored in the rule DB 107, to store in the collection classification DB 112 (S211). Here, the data collection function 114 may transfer the collected information to the data classification function 115, instead of storing in the collection classification DB 112.

Next, the apparatus 101 for identifying early status uses the data classification function 115 to perform an analysis process, such as morphological analysis, on the text part of the information collected in S211, or on the information stored in the collection classification DB 112, divide the text into each word, classify the results based on the classification rule 128 stored in the rule DB 107, add a classification tag to each of the words, and store in the collection classification DB 112 (S212). Here, the classification rule 128 describes the relationship between words and emergency events, such as fire, flood, tsunami, and crowd of evacuees. For example, when a word related to fire (for example, “smoke” and “flame”) is extracted as a result of the morphological analysis, a classification tag “fire” is added, for example, by one keyword or AND conditions of multiple words. Multiple classification tags may be added to one piece of information. Further, information not including any of the words included in the classification rule 128 is added with a classification tag of “no classification”, or deleted from the collection classification DB or is not registered. By adding “no classification” or deleting from the collection classification DB, the information unrelated to the disaster management measures is undisplayed, in order to prevent necessary information from being buried on the screen and to reduce the amount of data in the DB.

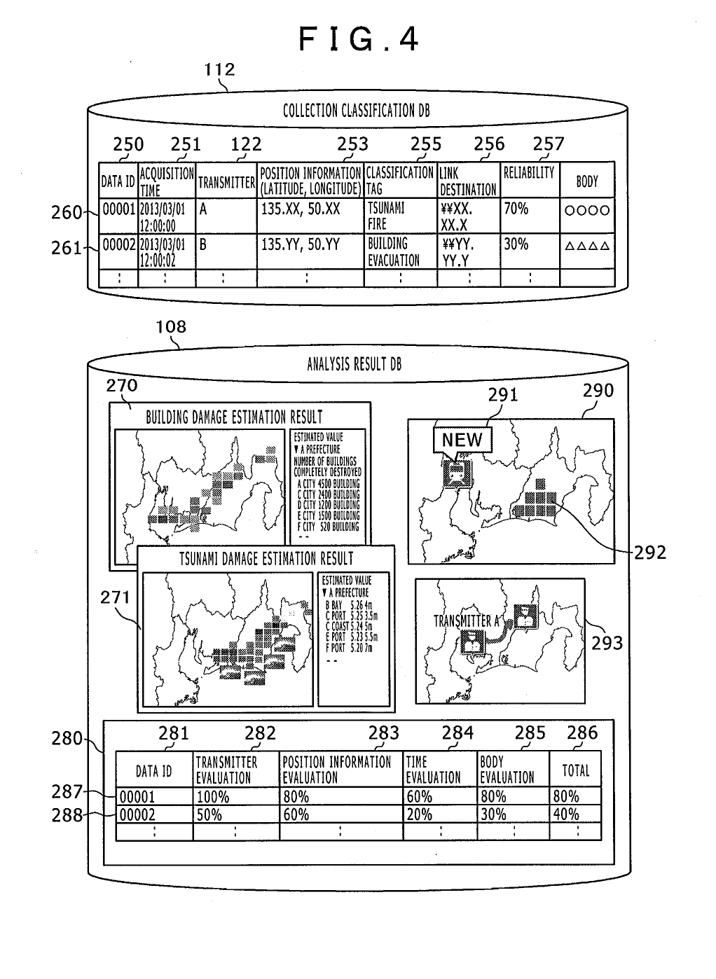

FIG. 4 shows an example of the configuration of the collection classification DB 112. For example, the information collected in S211 includes a metadata and a body 257 which is the data body. Here, the metadata includes data ID 250 added in S211 to identify the data, acquisition time 251, transmitter information 252 related to the information source (name, sensor type, etc.), position information 253 (for example, longitude, latitude), classification tag 254, link destination 255 such as image and video, and reliability 256 (described below in S222). The information is stored as records 260, 261, and so on.

The collection classification DB 112 accumulates a huge amount of information, so that it is desirable to accumulate data efficiently and effectively, by elimination of duplicate data or by deletion or compression of data according to the reference frequency, and the like. Here, there is no need to register values for all items as shown in the record 260, with respect to the information collected in S211. Items with no corresponding values may be left blank upon registration. For example, if the information does not have position information, the field of the position information 253 may be left blank. Further, when S212 is performed, a classification tag is added to each record, and the values of the added tag name, for example, “tsunami”, “fire”, and the like are registered in the item 254. Further, if the time information is not included in the collected information, the apparatus 101 for identifying early status may register the time when the particular information is collected, as the value of the acquisition time 251. Further, as a result of the analysis process such as morphological analysis in S212, when a ward related to the position information such as place name is extracted, the apparatus 101 for identifying early status may register the extracted word in the position information 253 of the record.

Now returning to FIG. 3, the information stored in the collection classification DB 112 is mapped to the map data included in the map data 110 as well as the satellite image data included in the satellite image DB 111, based on the values of the position information 253 showing the geographical position, such as the longitude, latitude, and altitude included in each record, by the geospatial integration function 118 (S213). If the information showing the geographical position is not the latitude and longitude (but the prefecture name, building name, etc.), the geospatial integration function 118 maps the information, for example, by converting the geographic position into the latitude and longitude of the prefectural government or into the latitude and longitude of the place where the building is located. In the case of repeated use of the mapped information, for example, the mapped information may be recorded in the field of the position information 253. Further, if there is no information showing the geographical position, it is possible to skip S213 and perform S214.

The apparatus 101 for identifying early status provides the damage identification screen 124 to the headquarters user 170, with respect to each of the records stored in the collection classification DB 112 and the analysis result DB 108, based on the acquisition time 251 included in each record, and based on the information mapped to the map data and the satellite image data in S213 (S214).

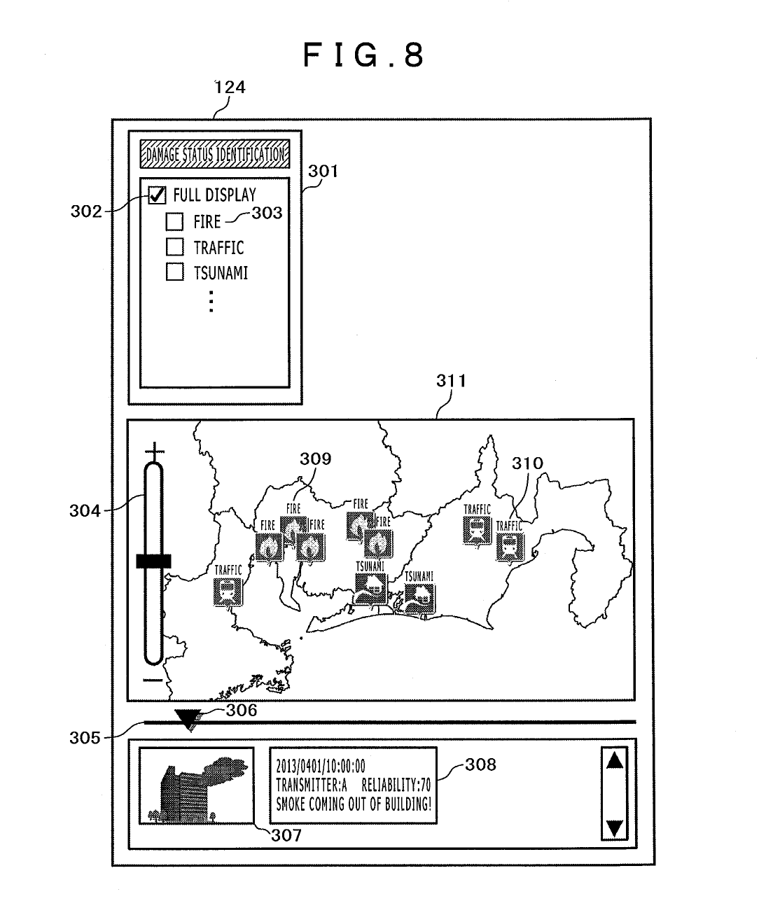

The damage identification screen 124 is shown in FIG. 8. The apparatus 101 for identifying early status displays an icon, and the like, corresponding to the classification tag 254 at the position mapped in S213, with respect to each of the records stored in the collection classification DB 112 and the analysis result DB 108, to support the headquarters user 170 to identify the status. For example, in the screen operation part 301 of the damage identification screen 124, when the headquarters user 170 checks a check box 302, all records registered in the collection classification DB 112 are displayed in a map display part 311. When displaying the records, icons such as “fire” icon 309 and “traffic” icon 310 are displayed at the positions mapped in S213, according to the classification tags. Here, with respect to a record with multiple classification tags, the apparatus 101 for identifying early status displays all or some of the multiple classification tags. For example, when the record has two classification tags of “tsunami” and “traffic”, the apparatus 101 for identifying early status displays the tag “tsunami” that is more important than “traffic”. The importance of the respective classification tags may be registered in advance, or may be registered by the headquarters user 170. When the headquarters user 170 presses an icon, the apparatus 101 for identifying early status displays the values of the acquisition time 251, transmitter 252, and body 257 of the record displayed by the icon, in a detail display part 308. At this time, when the field of the link destination 255 has a value, the apparatus 101 for identifying early status obtains the image, video, and the like of the link destination and displays in a link destination display part 307.

Further, with respect to the record displayed on the screen, the apparatus 101 for identifying early status maintains the visibility by not displaying old information after a certain period of time, based on the value of the acquisition time 251 included in the record. For example, in a time setting bar 305, the scales indicating the coordinates of the time axis are displayed in a unit of time or in a unit of day, and the like, where the present is shown in the right end and the past is shown in the left direction. The headquarters user 170 can set the time by sliding the time setting icon 306 to the past by a specific time. Further, it is possible to display two time setting icons 306 to display a specific time interval by sliding the time setting icons 306, to display the information for the period from 30 minutes ago to the present or display the information for the period from one hour ago to 30 minutes ago. It is desirable that the headquarters user 170 can freely change the time interval to be displayed.

Further, when the number of records with the same classification tag is small in an area as compared to the amount of collected information, the apparatus 101 for identifying early status does not display these records. When a predetermined number or more of such records are collected, the apparatus 101 for identifying early status displays an icon corresponding to the classification tag for the area, in order to maintain the visibility. Further, with respect to the information with low reliability (described below in S222), the apparatus 101 for identifying early status displays an icon corresponding to the classification tag in the area at the time when the amount of collected information with low reliability is greater than the amount of information with high reliability, to maintain the visibility. Further, when the headquarters user 170 changes the scale to be displayed in the map display part 311 by operating a scale change bar 304, the apparatus 101 for identifying early status changes the amount of information to be displayed according to the scale to maintain the visibility, in such a way that, for example, in a large area display, if 10 or more records with the same classification tag “fire” are present in an area (for example, within a radius of 10 km), the apparatus displays the icon of “fire” for the particular area, or displays only records with high reliability (or only records with low reliability). With the display of the damage identification screen 124 as described above, even if the amount of data collected by the apparatus 101 for identifying early status increases, it is possible to maintain the visibility and prevent the critical information from being buried.

The apparatus 101 for identifying early status may deliver the information collected in S211 and the information classified in S212 to the terminal device 150. The apparatus 101 for identifying early status uses the data conversion function 120 to convert one or multiple records registered in the collection classification DB 112 into a format stored in the format DB 109, which is suitable for the data transmission and reception with the terminal device 150 (S215).

Next, the apparatus 101 for identifying early status uses the data delivery function 121 to transmit one or more records converted in S215, to the terminal device 150 (S216). Here, the record(s) to be converted in S215 and transmitted in S216 may be extracted according to the position information of the terminal device 150 as well as the on-site user 180 who uses the information. For example, the apparatus 101 for identifying early status preferentially transmits a record with a value within a 10-km radius around the terminal device 150 as the position information 253, based on the position information obtained from GPS, the mobile phone base station, and the like, in the terminal device 150. Alternatively, when the on-site user 180 is responsible for evacuation guidance, the apparatus 101 for identifying early status preferentially transmits the record with “evacuation” as the value of the classification tag 254. In this way, it is possible to preferentially transmit the necessary information, even if the computer resources of the terminal device 150 and the network bandwidth used for data transmission and reception are limited.

The terminal device 150 uses the information reception/display function 152 to display one or more records received from the apparatus 101 for identifying early status, on the map by using the map data 153 or just browses (S217). Further, the terminal device 150 transmits the information (text, image, video, voice, etc.) that is collected or input by the on-site information collection function 151, to the apparatus 101 for identifying early status (S218). When transmitting, the terminal device 150 may transmit the information by converting to a format suitable for the data transmission and reception with the apparatus 101 for identifying early status. Further, it is also possible to obtain the position information from GPS, the mobile phone base station, and the like, and transmit the position information together with the information to be transmitted. The information transmitted in S218 is processed by the apparatus 101 for identifying early status in S211.

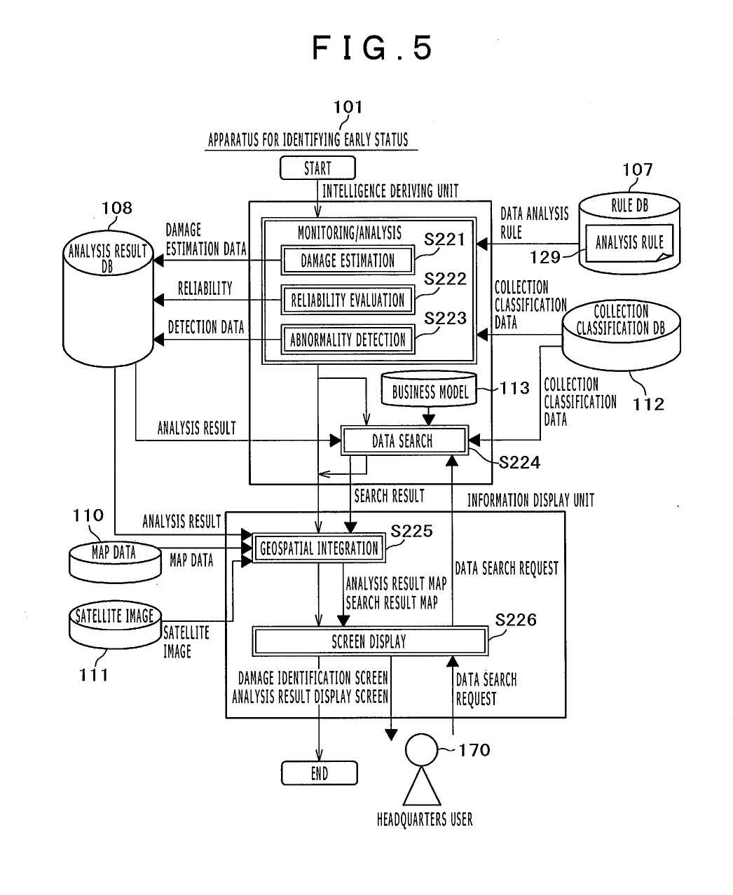

FIG. 5 schematically shows the information analysis flow 202 according to the present embodiment.

The apparatus 101 for identifying early status uses the monitoring/analysis function 116 to perform an analysis, based on the analysis rule 129 registered in the rule DB 107, by using the data accumulated in the collection classification DB 112.

The apparatus 101 for identifying early status uses simulation as means of damage estimation to estimate the damage caused by a disaster or emergency, and the progress of the status (S221). For example, the apparatus 101 for identifying early status estimates the number of houses totally or partially destroyed, as well as the human suffering associated with the destruction by using the earthquake intensity information and building information of each area. Further, the apparatus 101 for identifying early status estimates the arrival time of tsunami and its height in each port, the inundation range, and the human suffering associated with the tsunami event, from the earthquake intensity information and the seismic source information. Further, the apparatus 101 for identifying early status estimates the progress of fire in the future by using the fire occurrence information and the weather information. At this time, it is possible to calculate the damage estimation by sampling per 1 km radius and the like.

Further, as another analysis method, the apparatus 101 for identifying early status performs a reliability evaluation on each of the data records accumulated in the collection classification DB 112 (S222). In evaluation of the reliability of each record, for example, the following methods are used. The value of the item “transmitter” 252 of each record is used. For example, the apparatus 101 for identifying early status calculates the reliability based on whether the value of the transmitter is the name registered as the public user in advance (if the transmitter is the public user, the apparatus increases the value of reliability), based on the value of the item “reliability” 256 of other records with the same value of transmitter (that is, the average of the reliability of other records), based on whether the content of the transmitter is real name or tentative (if it is the real name, the apparatus increases the value of reliability).

Still another evaluation method is to use the values of the item “position information” 253 and the item “acquisition time” 251 in each record. For example, in S212, when a place name, building name, or other location that is extracted by the analysis process such as morphological analysis and registered as the value of the item “position information” 253, is geographically distant from the value (latitude, longitude, and the like) registered in the item “position information” 253 that is similarly obtained from GPS and registered in the item “position information” 253, or when the time and date included in the value of the item “body” 257 of the record is temporally distant from the time information included in the item “acquisition time” 251, or when the time information included in the item “acquisition time” 251 is older than the current time, the apparatus 101 for identifying early status reduces the value of reliability.

Further, when the information included in the value of the item “body” 257 of the record is expressed in a hearsay fashion such as “reportedly” and “allegedly”, or is a quotation from another information transmitter, the apparatus for identifying early status reduces the value of reliability. Further, as another evaluation method, when a video or image is added to the item “link destination” 255 of each record, the apparatus for identifying early status increases the degree of reliability. Further, when multiple records with the same classification tag are present in a geographic range (for example, within a radius of 1 km) by referring the item “position information” 253 of the record, the apparatus for identifying early status increases the value of reliability according to the number of records present in the particular ranges with the same classification tag.

The apparatus 101 for identifying early status calculates and registers the value of the item “reliability” 256 of each record, from the reliability set based on each of the evaluation methods described above. In calculation, each evaluation method is weighted to calculate the value of reliability by point addition, averaging or other arithmetic operations. Here, the process of S222 may be performed before the data classification of S212 described above. For example, it is possible to reduce the size of the database by performing the reliability evaluation on the data collected in S211, performing the process of S212 only when the reliability is a certain value or higher, adding a classification tag to the record, and storing the processed data in the collection classification DB 112.

As still another analysis method, the apparatus 101 for identifying early status detects the occurrence of an abnormality (S223) in the following cases: that is, with respect to the records stored in the collection classification DB 112, when the number of temporal data changes, such as when the number of records with the same value of the classification tag 254 quickly increases or decreases; when the number of geographic data decreases, such as when the number of records with the position information (latitude, longitude, etc.) 253 within a certain range quickly increases or decreases; or in an area within a certain range (within a radius of 1 km from a certain point (latitude, longitude), etc.), when the number of records with the position information (latitude, longitude) 253 within the range is small as compared to the population included in the map data 110, the predicted hazard map (damage prediction), and the damage estimation value calculated in S221 or other values.

Further, when the difference in the classification tag is large as compared to the records with the same classification tag (for example, compared to the numbers of records with the classification tag of “fire”) by referring to the values of the classification tag 254 of the records registered in the collection classification DB 112 in the past disasters, it may be detected as the occurrence of an abnormality.

Further, the apparatus 101 for identifying early status follows the movement of the transmitter by referring to the contents of the item “transmitter” 252 and the item “position information” 253 with respect to the records stored in the collection classification DB 112. Then, the apparatus 101 for identifying early status extracts the number of those who have difficulty going home as well as the crowded condition, from the speed of the movement as well as the number of transmitters (the number of records) in an area (latitude, longitude, etc.) within a certain range. For example, the apparatus 101 for identifying early status extracts a record with “A” for the value of the item “transmitter”, and obtains the value of the position information 253 of the extracted record. Thus, it is possible to make the movement of the transmitter A visible by mapping the obtained value of the position information 253 on the map in S225. Further, it is also possible to calculate the movement speed from the distance between the mapping points as well as the difference between the acquisition times, by referring to the values of the acquisition time 251 of the records mapped on the map. Further, when there is a record with a classification tag, such as “fire”, in the area (latitude, longitude, etc.) within the same range as that of the position information (obtained from GPS, etc.) transmitted from the terminal device 150 of the transmitter, the apparatus 101 for identifying early status can extract the record as the transmitter is present in the dangerous area.

By the monitoring/analysis process of S221, S222, and S223, it is possible to integrate the information with various reliabilities collected from SNS or other tools, with other information to provide information capable of contributing to the disaster management activities. For example, the damage estimation calculated in S221 can contribute to the disaster management of developing a support plan by comparing the damage estimation to the predicted hazard map (damage prediction), to determine whether the planned activity (for example, the amount of goods to be delivered) is appropriate or whether it is necessary to perform an activity other than the panned one, and the like. The reliability calculated in S222 can be used to control the reliability of all the displayed information, such as by displaying only records with high reliability. Further, by comparing the reliability calculated in S222 to the value of the body 257 of the record with the same classification tag as the value of the body 257 of the record with low reliability, which has the position information within a certain range and high reliability, it is possible to extract the value of the body 257 of the record with low reliability, to prevent the spread of false information on the network 160 by transmitting correct information from the headquarters user 170 to dispel the false information. In this way, it is possible to reduce the proportion of the false information to the information transmitted and received on the network 160, and to increase the reliability of the information collected by the apparatus 101 for identifying early status.

The classification tag and area detected as the occurrence of an abnormality in S223 can contribute to the efficiency in information collection as well as the instruction of flexible management activities. For example, with respect to an area in which the number of records with the classification tag of “fire” and with high reliability quickly increases, headquarters user 17 sends firefighters to the area. Further, with respect to an area in which the number of records with the position information (latitude, longitude, etc.) 253 within the range is small as compared to the population included in the map data 110, the predicted hazard map (damage prediction), and the damage estimation value calculated in S211 or other values, the headquarters user 170 asks the on-site user 180, public organization staff, or other personnel to collect information on the particular area. Further, with respect to an area from which the number of those who have difficulty going home and the crowded condition are extracted, the headquarters user 170 asks the on-site user 180, public organization staff, or other personnel to send staff for evacuation, and to provide break rooms and food in public facilities or other places within the particular area. Further, the headquarters user 170 issues a warning to information terminals present in the dangerous area to evacuate immediately.

The results of the execution of S221, S222, and S223 are registered in the analysis result DB 108. The configuration example of the analysis result DB 108 is shown in FIG. 4. For example, as for the result of the execution of S221, the position information and the estimated value calculated for the position are registered. For example, in the case of tsunami damage estimation, the position information, tsunami arrival time, height, inundation depth, and the like are registered as a tsunami damage estimation result 271. It is also possible to register as a hazard map (which is a map on which the damage estimation result is superimposed).

As for the result of the execution of S222, the reliability calculated by the data ID and each evaluation method for the record whose reliability is evaluated, are registered in the analysis result DB. For example, a reliability 282 evaluated by the transmitter information, a reliability 283 evaluated by the position information, a reliability 284 evaluated by the time, a reliability 285 evaluated by the content of the body (which is expressed in a hearsay fashion or is a quotation, and the like), and an overall reliability 286 comprehensively evaluated from each evaluation result. Here, the overall reliability 286 of records 287 and 288 is the average value of each of the reliabilities. However, it is also possible to calculate the overall reliability by weighting for each evaluation. In this case, the unit is not necessarily a percentage. Note that the reliability that is comprehensively evaluated may be registered in the item “reliability” of the collection classification DB. Further, with respect to each of the records whose reliability is evaluated, it is possible to update the reliability by performing the process of S222 on all or some of the records, regularly or based on the instruction from the headquarters user 170.

As for the classification tag with respect to which the number of records collected in an area quickly increases (or decreases) as a result of the execution of S223, the position information (of the center point) of the particular area, as well as the value of the classification tag are registered (for example, data 291 of record 290). Further, with respect to a point at which the number of records with the position information (latitude, longitude, etc.) 253 within a certain range (for example, within a radius of 1 km from the point (latitude, longitude)) is small as compared to the population included in the map data 110, the predicted hazard map (damage prediction), the value of the damage estimation calculated in S221 or other values, the value of the position information of the particular point is registered (for example, data 292 of the record 290). Further, the result of the extraction of the transmitter movement (position information) is registered as shown in a record 293. The records 270, 271, 290, and 293, which are registered in the analysis result DB as described above, are not necessarily registered in the analysis result DB 108. It is possible to perform the process of S221, S222, S223, and then perform S225 by skipping the registration of the records in the analysis result DB 108.

The apparatus 101 for identifying early status uses the data search function 117 to extract a record from the collection classification DB 112 and the analysis result DB 108 (S224). In search, the headquarters user 170 specifies the item name of the records of the collection classification DB 112 and the analysis result DB 108, as well as the item value (content of each item) through the disaster identification screen 124 and the analysis result display screen 125, to extract the corresponding record. For example, the headquarters user 170 specifies a classification tag “fire” and a time period “one day” as search keys. In this case, the data search function 117 of the apparatus 101 for identifying early status extracts the record with “fire” included in the content of the item “classification tag”, and within the range from one day before to the current time for the content of the item “time”. Alternatively, the data search function 117 extracts the corresponding record from the scope of business of the headquarters user 170 included in the business model 113. For example, when the headquarters user 170 is in charge of A Prefecture, the data search function 117 extracts the record with the location (latitude, longitude, etc.) in the range of A Prefecture. Further, if an abnormality is detected in the previous step S223, the data search function 117 extracts records contributing to the abnormality detection. For example, when the number of records with the classification tag “fire” quickly increases, the data search function 117 extracts only the records with the classification tag “fire”. Further, when searching with the value of the item “transmitter”, for example, the data search function 117 extracts records with “A” for the value of the item “transmitter” 252.

The record registered in the analysis result DB 108 as well as the record extracted in S224 are mapped to the map data included in the map data 110 as well as the satellite image data included in the satellite image DB 111, based on the information showing the geographical position such as latitude, longitude, altitude, and the like included in each record, by the geospatial integration function 118 (S225). If the information showing the geographical position is not the latitude and longitude (but showing the prefecture's name, building name, etc.), for example, the geospatial integration function 118 converts the data into the latitude and longitude of the prefectural government, or into the latitude and longitude of the location in which the building is located for mapping. For example, the mapped information may be recorded in the analysis result DB 108 as the mapped information could be used repeatedly. Further, if there is no information showing the geographical position, the geospatial integration function 118 may skip S225 and perform S226.

The apparatus 101 for identifying early status provides the analysis result display screen 125 to the headquarters user 170, with respect to each of the records stored in the analysis result DB 108, based on the values such as the acquisition time included in each record, and on the information mapped to the map data and the satellite image data in S225 (S226). Further, the extracted records in S224 are provided to the headquarters user 170 through the damage identification screen 124 and the analysis result display screen 125, based on the values such as the acquisition time included in each record, and on the values of the position information mapped to the map data and the satellite image data in S225.

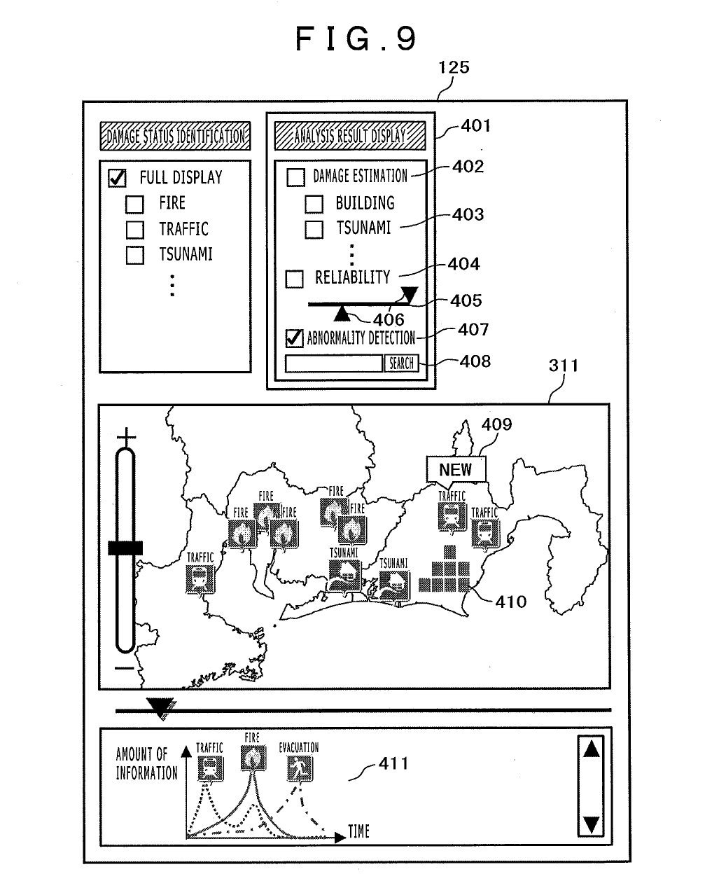

The analysis result display screen 125 is shown in FIG. 9. The analysis result display screen 125 displays the image corresponding to the analysis result at the position in which the data is mapped in S225, with respect to each of the records stored in the analysis result DB 108, to support the headquarters user 170 to identify the status. For example, when the headquarters user 170 checks a damage estimation check box 402 and a tsunami check box 403 in a screen operation part 401 of the analysis result display screen 125, the tsunami damage estimation result 271 stored in the analysis result DB 108 in S221 is displayed in the map display part 311. Further, when the headquarters user 170 checks a reliability check box 404 and then slides an icon 406 of a reliability operation bar 405, for example, when sliding the black triangle icon to the right, the analysis result display screen 125 only displays records whose reliability is a certain value or higher with respect to the records registered in the collection classification DB 112, in the map display part 311, for example, even if the headquarters user 170 checks the check box 302 in the screen operation part 301 of the damage identification screen 124. The headquarters user 170 can specify the range of the reliability to be displayed (for example, the range between low reliability and medium reliability) by sliding the black triangle icon to the left.

Further, when the headquarters user 170 inputs the item name and item value (content of each item) of the records of the collection classification DB 112 and the analysis result DB 108 and presses a search button 408, the analysis result display screen 125 extracts the corresponding record and displays an icon and the like corresponding to the classification tag at the location mapped in the map display part 311 in S225. Further, when the headquarters user 170 checks an abnormality detection check box 407, the analysis result display screen 125 displays an icon 409 of a classification tag with respect to which the number of records collected in an area quickly increases (or decreases), at the location (of the center point) of the area. Further, in an area within a certain range (for example, within a radius of 1 km from a certain point (latitude, longitude)), when the number of records with the position information (latitude, longitude, etc.) 253 within the range is small as compared to the population included in the map data 110, the predicted hazard map (damage prediction), and the damage estimation calculated in S221 or other values, in other words, with respect to the area registered as an information vacuum area, the analysis result display screen 125 displays an icon indicating information vacuum (410 in FIG. 9). Here, even if the abnormality detection check box 407 is not checked, it is possible to automatically display the icon indicating abnormality detection at the time of the execution of S223 and S225, or other timings. Further, in S223, it is possible to display the results of the analysis of the change in the number of records with the same value of the classification tag 254 with respect to the records stored in the collection classification DB 112, for example, in such a way that the relationship between the number of records and the time is shown for each classification tag, in a graph as shown in 411 of the analysis result display screen 125.

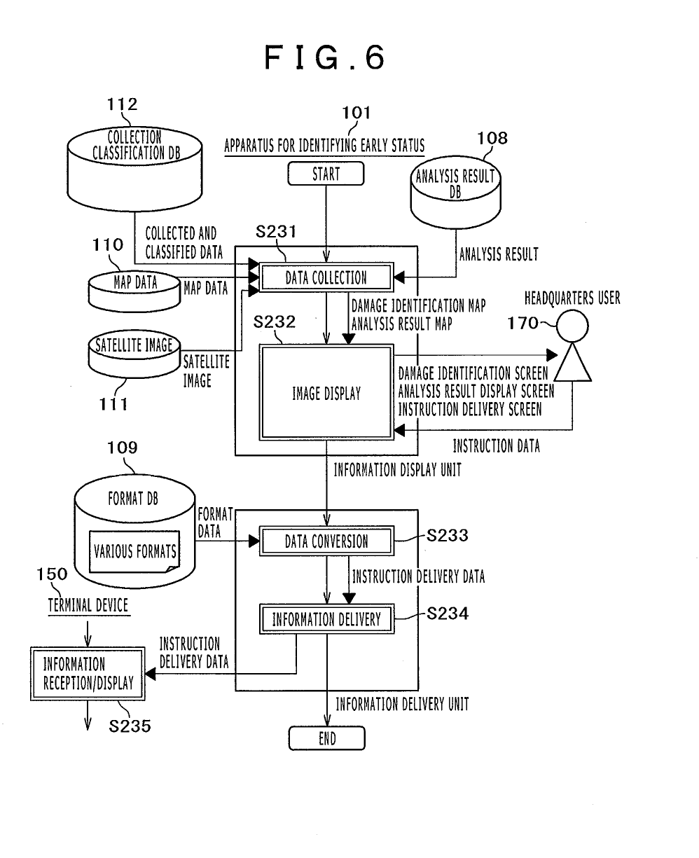

FIG. 6 schematically shows the instruction delivery flow 203 according to the present embodiment.

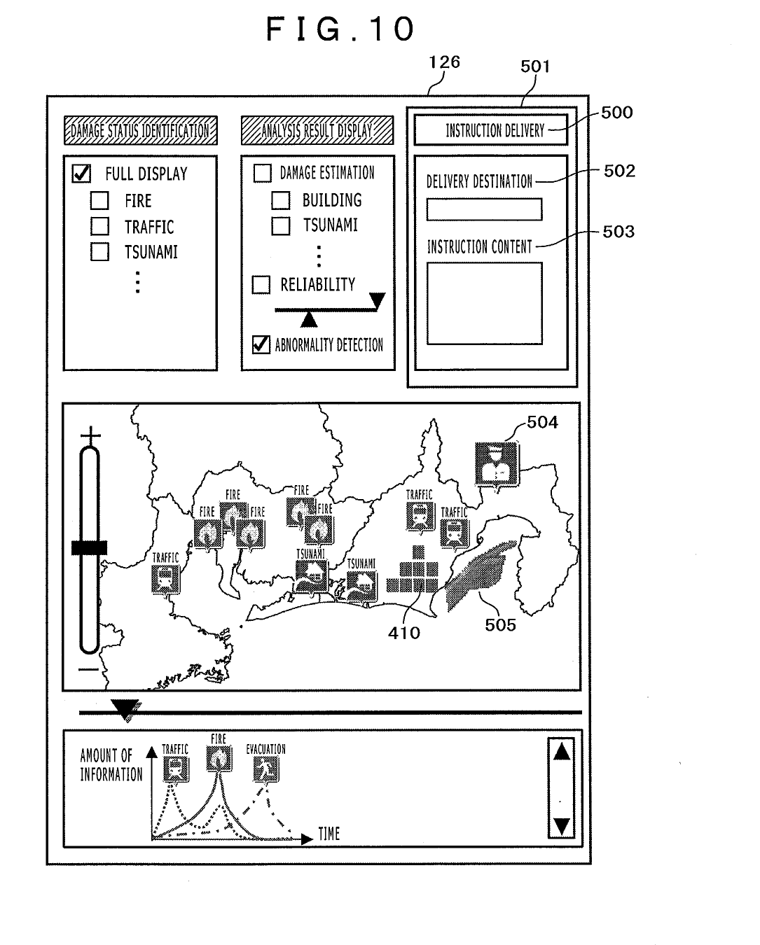

The apparatus 101 for identifying early status performs the process of S213 and S225 on the records of the collection classification DB 112 and the analysis result DB 108 that are collected by the status monitoring identification flow 201 and the information analysis flow 202, to map the collected data to the map data included in the map data 110 as well as the satellite image data included in the satellite image DB 111 (S231). Then, the apparatus 101 for identifying early status provides the mapped data to the headquarters user 170 through the damage identification screen 124 and the analysis result display screen 125. Here, the apparatus 101 for identifying early status displays the instruction delivery screen 126 for the headquarters user 170 to input the instruction destination, the instruction content or other information, on the damage identification screen 124 and the analysis result display screen 125 (S232). As for the timing of the display of the instruction delivery screen, a start button may be provided in the damage identification screen 124 and the analysis result display screen 125 in advance, to display the identification delivery screen 126 when the headquarters user 170 presses the start button. Alternatively, the headquarters user 170 may press the map or satellite image displayed on the damage identifying screen 124 or the analysis result display screen 125 to display the instruction delivery screen 126. The instruction delivery screen 126 is shown in FIG. 10.

In the instruction delivery screen 126, the headquarters user 170 determines the instruction and information by using the information obtained from the damage identification screen as well as the analysis result display screen 125, and inputs the instruction and information to an instruction content input part 503 on the screen operation part 501 for the on-site user 180. Then, the headquarters user 170 presses a delivery button 500 to transmit the input content to the on-site user 180. For example, the headquarters user 170 sets the on-site user 180 to the delivery destination input part 502 as the delivery destination. Then, the headquarters user 170 inputs an information collection instruction in an instruction content input part 503 by pressing an information insufficient area 410 displayed in the analysis result display screen 125, namely, the area for which information collection is required, and transmits to the on-site user 180. When specifying the delivery destination, the headquarters user 170 may specify the map or satellite image displayed on the damage identification screen 124 or the analysis result display screen 125, to transmit the same instruction and information to multiple terminal devices 150 present within the range. Further, the position of the on-site user 180 may be displayed by an icon (for example, as shown in 504), based on the position information (obtained from GPS or other tools) transmitted from the terminal device 150. In this case, the headquarters user 170 can specify the delivery destination by pressing the icon. Also, when inputting the information, only information with low reliability from the damage identification screen 124 may be displayed. If the displayed information is incorrect information, namely, false information, the headquarters user 170 may input correct information and transmit to the terminal device 150 to prevent the spread of false information. The information source 130 and the information system 140 may be specified as the destination of the instruction and information, in addition to the terminal device 150. Here, by comparing the value of the body 257 of the record with low reliability to the value of the body 257 of the record that has the same classification tag and the position information within a certain range with high reliability, it is possible to determine whether or not the value of the body 257 of the record with low reliability is false.

The apparatus 101 for identifying early status delivers the information input by the instruction delivery screen 126 in S232 to the terminal device 150. Then, the apparatus uses the data conversion function 120 to convert the information input by the instruction delivery screen 126 into a format for data transmission/reception with the terminal device 150, which is stored in the format DB 109 (S233). Next, the apparatus uses the data delivery function 121 to transmit the data converted in S233, to the terminal device 150 which is the destination input by the instruction delivery screen 126 (S234). Further, by the same process as S215 and S216, the apparatus 101 for identifying early status may convert one or multiple records registered in the collection classification DB 112 and the analysis result DB 108 into a format for data transmission/reception with the terminal device 150, which is stored in the format DB 109, and transmit to the terminal device 150.

The terminal device 150 uses the information reception/display function 152 to receive the data transmitted from the apparatus 101 for identifying early status in S234, and browse by using the map data 153 or browse directly (S235).

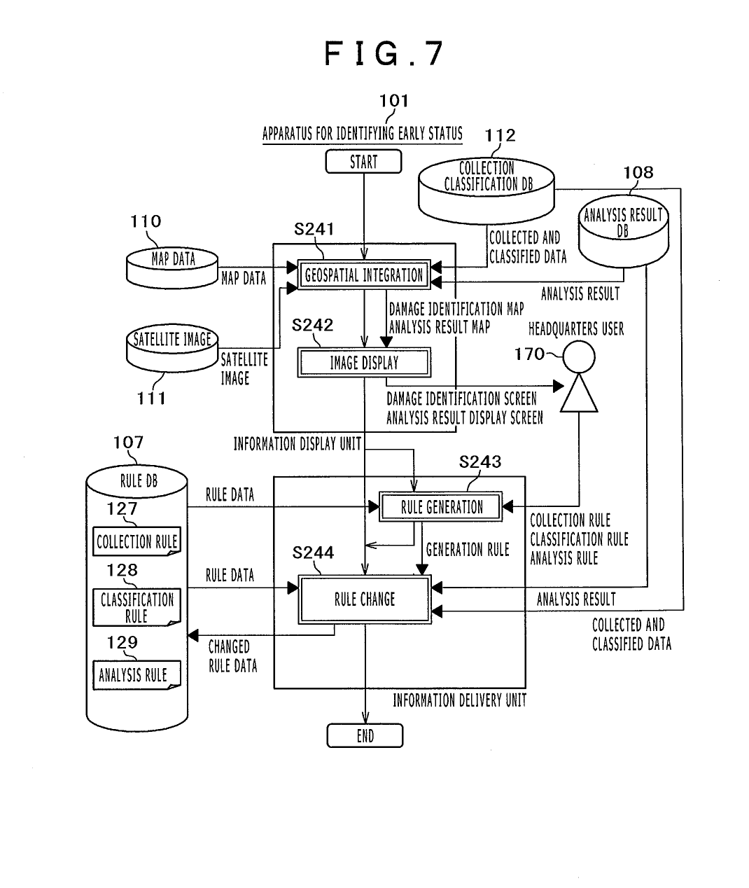

FIG. 7 schematically shows the information improvement flow 204 according to the present embodiment.

By the process of S211 and S212 described above, the apparatus 101 for identifying early status collects data based on the collection rule 127, classifies the collected data based on the classification rule 128, and registers the data in the collection classification DB 112 constantly on a regular basis. Further, the data registered in the collection classification DB 112 are analyzed based on the analysis rule 129 and registered in the analysis result DB 108 by the process of S221, S222, and S223 described above.

The data registered in the collection classification DB 112 and the analysis result DB 108 are mapped to the map data included in the map data 110 as well as the satellite image data included in the satellite image DB 111, by the same process as S213 and S225 described above (S241). Further, the data registered in the collection classification DB 112 and the analysis result DB 108, or the data mapped to the map data and the satellite image are provided to the headquarters user 170 through the damage identification screen 124 and the analysis result display screen 125, by the same process as S214 and S226 (S242).

Here, according to the present embodiment, it is possible to improve the amount and quality of the data by changing the collection rule 127, the classification rule 128, and the analysis rule 129 according to the data registered in the collection classification DB 112 and the analysis result DB 108. This can allow the headquarters user 170 and the on-site user 180 to take measures quickly and effectively.

Each of the rules can be changed by the apparatus 101 for identifying early status automatically or changed through the headquarters user 170. First, the case of automatically changing the individual rules by the apparatus 101 for identifying early status is described below.

The apparatus 101 for identifying early status uses the rule change function 123 to automatically change the collection rule 127, the classification rule 128, and the analysis rule 129 (S244). It is possible to perform S244 alone, independently of the execution of S241, 242, and S243. Examples of the change of the respective rules will be described below.

The collection rule 127 is changed, for example, so as to reduce the collection frequency of data other than the information whose transmitter is the public user, with respect to the area with more than a certain number of sensors and data with high reliability. Further, if an abnormality is detected in S223 by the monitoring/analysis function 116, for example, when data with the classification tag of “fire” is newly emerged or quickly increased, the collection rule 127 is changed to increase the frequency of collection with “fire” or related words, such as “smoke” and “flame”, as keywords. Further, when the number of data collected within a certain period of time is greater than a predetermined threshold (namely, when the amount of collected data is large and the process load exceeds the computational capability of the apparatus 101 for identifying early status), the collection rule 127 is changed to preferentially collect the information to which images and video or other data are added.

The classification rule 128 is changed when a small number of records have the same classification tag as a result of referring to the classification tag 254 of the records in the collection classification DB 112. For example, when the number of records with the classification tag of “fire” is small, the classification rule 128 is changed to increase the number of records with the classification tag of “fire”, by such means as adding the classification tag of “fire” not only to information including words that are relatively closely related to “fire”, such as “smoke”, “flame”, and “extinction”, but also to the information including words that are distantly related to “fire”, such as “smell” and “red”. In this way, the detection sensitivity of “fire” is increased. Here, with respect to the information including the distantly related words, the reliability related to the classification tag “fire” may be evaluated to be low by the liability evaluation of S222, and this value may be registered in the item “reliability” of the record.

The analysis rule 129 is changed to reduce the threshold of the abnormality detection when the number of records registered in the collection classification DB 112 is small. On the other hand, when the number of records registered in the collection classification DB 112 is huge, the analysis rule 129 is changed to increase the threshold of the abnormality detection. For example, it may be described in the analysis rule to detect that the number of records with the classification tag “fire” in an area exceeds 10 when the number of records registered in the collection classification DB 112 is small, and display the icon of “fire” in the corresponding area on the map in the damage identification screen 124, or to detect when the number of records registered in the collection classification DB 112 increases, and display the icon “fire” when the number of records exceeds 100. Further, it may also be described in the analysis rule to detect similar disasters or emergencies in the comparison with the content of the collection classification DB 112 and the content of the analysis result DB 108 in the past disasters, and present the data as reference information.

Next, the case of changing each rule through the headquarters user 170 is described below.

The headquarters user 170 may change each rule similarly as described above, based on the similar determination used by the apparatus 101 for identifying early status to change each rule in S244, as a result of browsing the damage identifying screen 124 and the analysis result display screen 125 that are presented in S242. It is also possible to update the data by generating each rule from the business and personal interest of the headquarters user 170 or from new ideas about the analysis method (S243).

Note that in the above description, each rule is changed when the data registered collection classification DB 112 and the analysis result DB 108 are changed, namely, when a critical event such as a disaster occurred. However, each rule may also be changed regardless of the occurrence of a critical event. For example, each rule may be changed when the target to be observed is changed, such as when assuming new risk or when using in the normal operation regardless of the presence of a critical event. Further, it is also possible to change the classification rule and the analysis rule, by comparing and evaluating the fact of the event that has occurred and the damage during the disaster, to the content of the collection classification B 112 (the status of the addition of classification tags) and the content of the analysis result DB 108 (the results obtained from the analysis and extraction), after the implementation of the disaster management measures.

According to the instruction delivery flow 203 and the information improvement flow 204, during the time period when the amount of information that can be collected is small immediately after the occurrence of a disaster or emergency, the apparatus 101 for identifying early status increases the use of the information with relatively low reliability delivered from common residents. Then, the apparatus 101 for identifying early status provides information for identification and analysis of the damage status or other disaster-related conditions, to the headquarters user 170. Further, the apparatus 101 for identifying early status gradually increases the reliability of the information to be collected through instruction delivery to the on-site user and through improvement of each rule, to identify and analyze the damage status or other disaster-related conditions more accurately, in order to provide information capable of contributing to the accurate determination and management measures of the headquarters user 170. This allows the headquarters user 170 to quickly and continuously make decisions regarding determination and management measures, under critical conditions such as the occurrence of an unexpected event, for example, in the case of insufficiency of the information from the sensors, information systems, and disaster management organizations, which are initially expected to be the information sources.

The screens shown in FIGS. 8, 9, 10 are an example, and it is possible to freely arrange the check boxes, buttons, and display areas of each screen. Further, the screen can be divided into multiple parts.

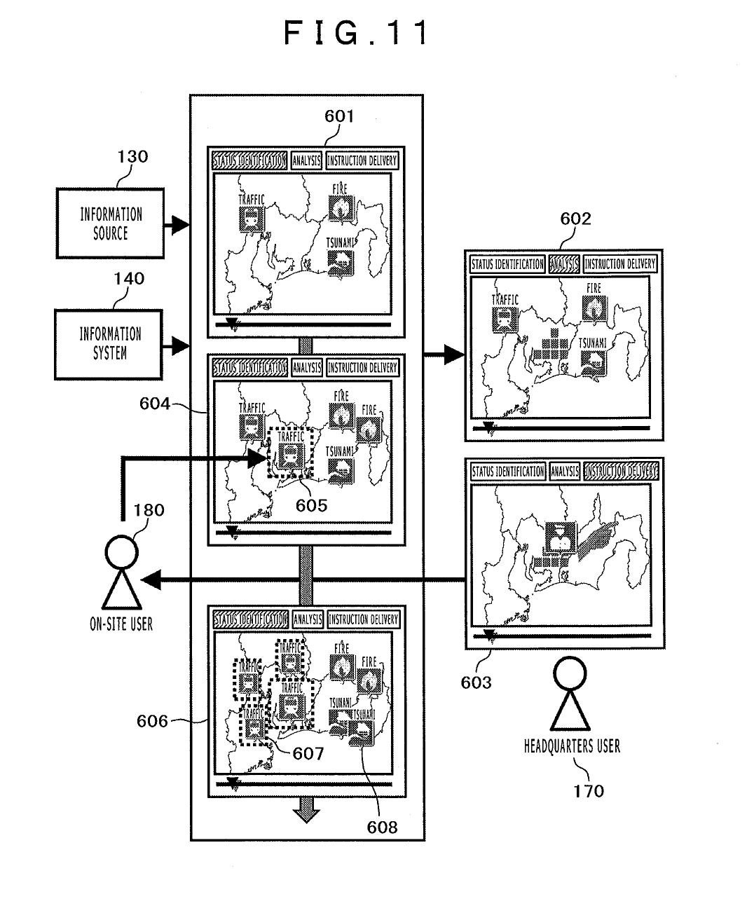

The following will describe an example of performing a series of process flows (the status monitoring/identification flow 201, the information analysis flow 202, the instruction delivery flow 203, and the information improvement flow 204) described above, by using the screen example of FIG. 11. Note that, in FIG. 11, each screen is simplified and mainly shows the map display area 311.

By the status monitoring/identification flow 201, the apparatus 101 for identifying early status collects information with various reliabilities from the information source 130 such as sensors, as well as the information system 140 such as SNS, and displays in the damage identification screen 124 (screen 601). By the information analysis flow 202, for example, in an area within a certain range (within a radius of 1 km from a certain point (latitude, longitude)), when the number of records with the position information (latitude longitude, etc.) 253 within this range is small as compared to the population included in the map data 110, the predicted hazard map (damage prediction), and the damage estimation calculated in S221 or other values, in other words, with respect to the area registered as an information vacuum area, an icon indicating information vacuum is displayed (screen 602). By the instruction delivery flow 203, the headquarters user 170 instructs, for example, the on-site user 180 present in the area showing information vacuum displayed on the screen 602, to collect information on the information vacuum area (screen 603). Upon reception of the instruction, the on-site user 180 collects information from the area instructed by the headquarters user 170. Then, the on-site user 180 transmits the collected information to the apparatus 101 for identifying early status by the terminal device 150 and the like. The transmitted information is displayed on the damage identification screen, for example, as information 605 with high reliability, by the information monitoring/identification flow 201 (screen 604). This process is repeated with respect to the same on-site user or on-site users of other areas. Then, information 607 with high reliability is collected and displayed as shown in a screen 606. At the same time, information 608 with improved amount and quality is collected and displayed by the information improvement flow 204. The headquarters user 170 can make decisions about evaluation guidance, life-saving, support staff dispatch, and the like, by using the screens 601, 604, and 606, the information with improved amount and quality, and the results of the analysis by the information analysis flow.

By a series of information process flows described above, it is possible to take measures for an emergency such as a disaster, by quickly and accurately performing the cycle of information collection, analysis, decision making, and management measures.

With reference to FIGS. 1 to 11, it has been described the method that enables, for example, identification of the status immediately after a disaster mainly based on the information with low reliability of the information from SNS or other tools, while enabling identification of the status more accurately by collecting required area information and information with high reliability as time passes. According to the present invention, it is possible to collect information that can be collected at the time, to use for the status identification. Further, it is also possible to determine the area and type of information to be collected (or what information should be collected) to allow actions such as providing instructions to on-site information collection activities, as well as response activities such as rescue and relief. As a result, it is possible to quickly collect effective information or to provide effective personnel allocation and response activities.

Note that user authentication may be performed in the apparatus 101 for identifying early status and the terminal device 150, to provide access management such as limiting information that can be browsed according to the user. Further, it is possible to perform a process such as encryption on the information transmitted/received through the network 160, so that the encrypted data is decrypted only by the destination device.

Further, in the above embodiment, the apparatus 101 for identifying early status is placed in the disaster management organization to which the headquarters user 170 belongs. It is also possible that a service provider uses the apparatus 101 for identifying early status to provide damage identification, information analysis, instruction delivery, or other functions to the service user as services.

### Second Embodiment

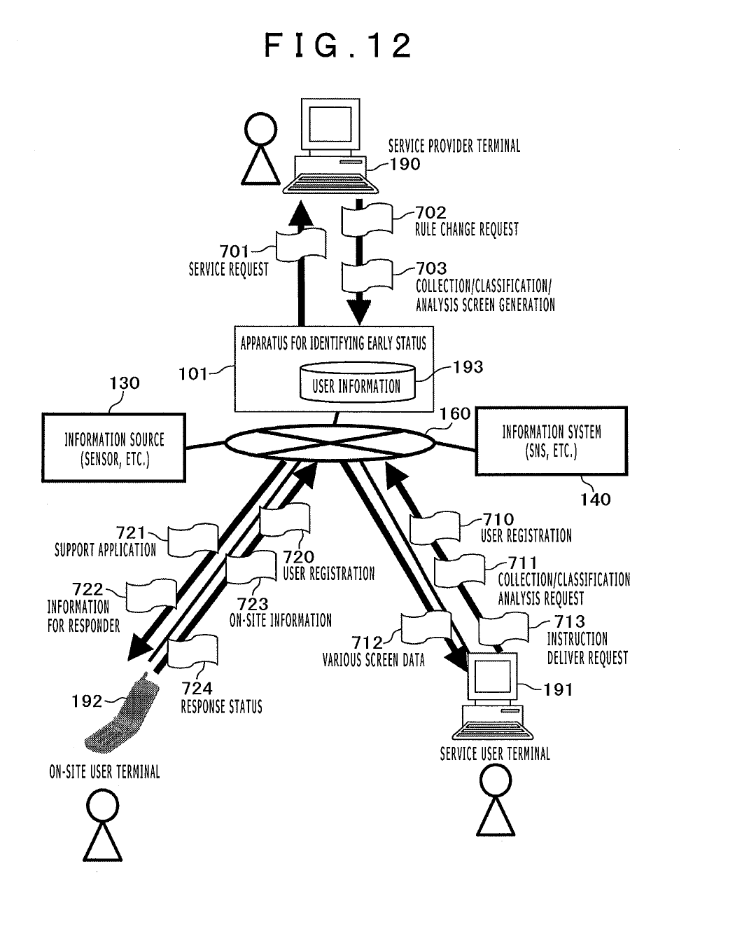

FIG. 12 shows an example of the form of service provision using the apparatus 101 for identifying early status.

A service provider places the apparatus 101 for identifying early status according to this embodiment in a building, server room, or data center owned by the service provider. Then, the service provider provides each process performed by the apparatus 101 for identifying early status, to the service user and on-site user as a service. A typical procedure for using the service is described below.

The service user accesses the apparatus 101 for identifying early status from a service user terminal 191. Then, the service user applies for use of the service by transmitting information on the service user (user name, mail address, etc.) as a use registration data 710. The apparatus 101 for identifying early status may transmit screen data for application to the service user terminal 191. In this case, the service user displays the screen by software such as a web browser, and input the use registration data on the screen to transmit the input data to the apparatus 101 for identifying early status.

The apparatus 101 for identifying early status receives the use registration data 710 from the service user, and registers the use registration data 710 in user information DB 193.

Note that in addition to the method for the application for the use of the service, it is possible that the service user transmits the registration data to the service provider by means of phone, facsimile, or mailing, and the service provider registers the user information in the apparatus 101 for identifying early status.

When the application for use is completed, the service user can use each process performed by the apparatus 101 for identifying early status as the service, by accessing the apparatus 101 for identifying early status from the service user terminal 191. For example, the apparatus 101 for identifying early status transmits the login screen data to the service user terminal 191. The service user displays the screen by software such as a web browser. Then, the service user inputs login data such as the user name on the screen and transmits the data to the apparatus 101 for identifying early status. The apparatus 101 for identifying early status authenticates the service user to determine whether the application for use has been completed, by referring to the received login data and the data registered in the user information 193. It is also possible to include a login password in the use registration data 710 to authenticate the service user by the password.

The apparatus 101 for identifying early status transmits screen data 712 of the damage identification screen 124 that is generated by performing the process of S213 and 214 on the records that are registered in the collection classification DB 112 in S211 and S212 as described above, to the user terminal 191 on which the service user logged in. The service user browses the damage identification screen 124 by software such as a web browser. Then, the service user obtains records registered in the collection classification DB 112 by operating the screen operation part 301 on the damage identification screen 124. Then, the service user browses the data on the damage identification screen 124. For example, the service user specifies data to be browsed by setting the classification tag (for example, displaying only records with the classification tag “fire”) on the damage identification screen 124. Then, the apparatus 101 for identifying early status transmits the corresponding record to the service user terminal 191 based on the specification. At this time, the apparatus 101 for identifying early status may transmit the record registered in the collection classification DB 112 by performing the same process as S215 and S216, to the service user terminal 191. In this case, the service user can browse by using the application and map data stored in the service user terminal 191.

Further, the apparatus 101 for identifying early status transmits the screen data 712 of the analysis result display screen 125 that is generated by performing the process of S225 and S226 with respect to the data registered in the collection classification DB 112 and the analysis result DB 108 as described above in S221, S222, and S223, to the service user terminal 191 on which the service user logged in. The service user browses the analysis result display screen 125 by using software such as a web browser. Then, the service user obtains the records registered in the collection classification DB 112 and the analysis result DB 108 by operating the screen operation part 401 on the analysis result display screen 125, to browse the data on the analysis result display screen 125.

Further, the apparatus 101 for identifying early status transmits the screen data 712 of the instruction delivery screen 126 to the service user terminal 191 on which the service user logged in. The service user browses the instruction delivery screen 126 by using software such as a web browser. Then, the service user inputs the delivery destination in the delivery destination input part 502 of the screen operation part 501, and inputs the instruction and information in the instruction content input part 503 of the screen operation part 501. Then, the service user presses the delivery button 500 to transmit the input information as instruction delivery request data 713 to the apparatus 101 for identifying early status. The apparatus 101 for identifying early status delivers the information that the service user input in the instruction delivery screen 126, to the delivery destination that the user also input in the instruction delivery screen 126, based on the instruction delivery request data 713.

The service user may change the collection rule 127, the classification rule 128, and the analysis rule 129, as a result of browsing the damage identification screen 124 and the analysis result display screen 125 that are provided by the apparatus 101 for identifying early status, based on the similar determination used by the apparatus 101 for identifying early status to change each rule in S244 as described above. Alternatively, the service user may generate each rule according to the business and personal interest of the headquarters user 170 or a new idea about the analysis method, and register the generated rules in the rule DB 107.

The service user transmits the collection/classification/analysis request 711 in which the generated or changed rules is described, to the apparatus 101 for identifying early status. The apparatus 101 for identifying early status registers the collection rule 127, the classification rule 128, and the analysis rule 129 for each service user in the rule DB 107, based on the collection/classification/analysis request 711. Then, the apparatus 101 for identifying early status provides the services such as damage identification, information analysis, and instruction delivery, by using the rules for each service user, to the service user.

The on-site user accesses the apparatus 101 for identifying early status from the on-site user terminal 192. Then, the on-site user applies for use of the service by transmitting the information on the on-site user (user name, mail address, etc.) as a use registration data 720. The apparatus 101 for identifying early status may transmit the screen data for application to the on-site user terminal 192. In this case, the on-site user can display the screen by using software such as a web browser, input the use registration data on the screen, and transmit the use registration data to the apparatus 101 for identifying early status. Further, the service user may transmit the use registration data to one or more on-site user terminals used on site at once.

Similarly to the service provision to the service user terminal 191 described above, the apparatus 101 for identifying early status provides the damage identification screen, the analysis result display screen, the instruction delivery screen, and the like, to the on-site user terminal 192. At this time, the apparatus 101 for identifying early status may transmit a support application 721 to the on-site user terminal 192 in which the user registration is completed, to allow the application to be installed in the on-site user terminal 192, in order to transmit and receive data between the apparatus 101 for identifying early status and the on-site user terminal 192, and display the damage identifying screen, the analysis result display screen, the instruction delivery screen, and the like. The support application 721 is an application specific to the service user, which reduces the size of transmitted/received data and simplifies the screen when the computer resources and the network bandwidth are limited.

Further, the apparatus 101 for identifying early status transmits the information and instruction content included in the instruction delivery request data 713 transmitted from the service user terminal 191, to the on-site user terminal 192 as responder information 722, by the same process as S233 and S234 as described above. The on-site user performs information collection and other activities based on the received responder information 722. Then, the on-site user transmits the collected information as on-site information 723, or the response status as response status 724, to the apparatus 101 for identifying early status, for example, by using the support application 721.

The above shows an example in which the service user or the on-site user refers to the records in the DB and changes the rules through different types of screens provided by the apparatus 101 for identifying early status, by using the service user terminal 191 or the on-site user terminal 192. However, it is also possible that the service provider receives a service request 701, such as an information collection request, an information analysis request, an instruction delivery request, and a rule change request, from the service user terminal 191 or the on-site user terminal 192. In this case, the service provider can access the apparatus 101 for identifying early status from the service provider terminal 190 to register the collection rule 127, the classification rule 128, and the analysis rule 129 for each service user, by the same process as S243 as described above. Further, the service provider may perform the processes that the service user terminal 191 and the on-site user terminal 192 perform on the screens in place of the users, and transmit the results to each terminal. More specifically, the service provider may display the information in the map display area 311, for example, capture the displayed screen, and transmit to the service user terminal 191 and the on-site user terminal 192, by operating the damage identifying screen 124, the analysis result display screen 125, and the instruction delivery screen 126, which are provided by the apparatus 101 for identifying early status, on the service provider terminal.

As described above, according to the present embodiment, the responder to an event such as a disaster can quickly and continuously collect information on the event that occurs or may occur, while assuring minimization of the influence of incorrect or false information as well as the information search capability, even under conditions in which an unexpected event may occur. Thus the responder can effectively identify the status.

Further, it is possible to take measures according to the status and to collect more variable information, by using the information presented for status identification.

It is to be understood that the present invention is not limited to the embodiments described above, and various modifications may be included. For example, the foregoing embodiments have been described in detail to clearly explain the present invention, and are not necessarily limited to those having all the configurations described in the particular embodiments.

Further, some or all of the configurations, functions, process parts, process methods or other components of the above embodiments may be implemented in hardware, for example, by a design with an integrated circuit. Further, the configurations, functions or other components described above may be implemented in software by a processor interpreting and executing program for implementing each function. The information such as programs, tables, and files implemented by each function can be placed in a storage device such as a memory, hard disk, or SSD (Solid State Drive), or in a storage medium such as an IC card, SD card, or DVD.

Further, the control and information lines that are considered to be necessary for explanation are shown, and all of the control and information lines are not necessarily shown in terms of the product. In practice, substantially all arrangements may be considered to be mutually interconnected.

1-16. (canceled)

17. A method for identifying an early status in an apparatus for identifying an early status to analyze and display data by collecting, classifying, and registering information about an event that occurred, the method comprising the steps of:
collecting information transmitted from a terminal device by an information transmitter, summarizing content of the collected information to create a summary, adding the summary to the information, and registering the results in a database;
calculating a reliability value of the collected information by analyzing the information transmitter and the content of the information;
when a critical event has occurred, increasing the use of information with low reliability and displaying the information to a user;
instructing an on-site user present in an area determined to have deficient information to collect information within the information deficient area; and
repeating the collection, classification, analysis, and display of the information of a report received from the on-site user, and the instruction of collecting information, to increase the reliability of the displayed information.

18. The method for identifying early status according to claim 17,
wherein items for which the content included in the collected information is summarized include at least acquisition time, transmitter, position information, classification tag, link destination to an image or video, and reliability.

19. The method for identifying early status according to claim 17,
wherein, as for the calculation method of the reliability of the collected information, the method for identifying early status calculates the reliability value of the information transmitted by the transmitter, according to whether the information transmitter is registered as a public user, whether the content of the transmitter is a real name or tentative, or according to the reliability of one or more information pieces transmitted by the same transmitter before transmitting the particular information.

20. The method for identifying early status according to claim 17,
wherein, as for the calculation method of the reliability of the collected information, with respect to the information transmitted by the information transmitter, the method for identifying early status adds higher reliability than the reliability of the information including some or all of the information transmitted by another information transmitter, to the information originally generated by the particular information transmitter.

21. The method for identifying early status according to claim 18,
wherein, as for the calculation method of the reliability of the collected information, the method for identifying early status increases the value of the reliability of the information, by referring to the database with respect to the information transmitted by the information transmitter, according to the number of registrations of information added with a classification tag of the same summary, within a certain geographic range, based on the position information of the summary added to the information.

22. The method for identifying early status according to claim 18,
wherein the method does not register the collected information in the database or deletes the information from the database, based on the result of the summary generated by the data collection process as well as the calculated reliability.

23. The method for identifying early status according to claim 17,
wherein, in an area within a certain geographic range, when the amount of information registered in the database is compared to the number of inhabitants of the area and compared to the estimated damage in the area, and when the amount of information is smaller than the estimated amount of information, the apparatus for identifying an early status extracts the particular area as the information deficient area.

24. The method for identifying early status according to claim 18,
wherein, with respect to the information registered in the database, the apparatus for identifying early status does not display information after a certain period of time,
wherein, with respect to the information registered in the database, when the amount of information with a similar classification tag is small in an area according to the amount of information registered in the database, the apparatus does not display such information,
wherein, with respect to the information registered in the database, when the amount of such information is a certain value or higher, the apparatus displays the classification tag of the area, and
wherein, with respect to the information registered in the database, when the sum of the reliabilities added to one or more information pieces with a similar classification tag in an area is a certain amount or higher, the apparatus displays the classification tag in the area.

25. The method for identifying early status according to claim 18,
wherein, with respect to the collected information registered in the database, the apparatus for identifying early status delivers information to request information collection to a terminal device present in an area in which the amount of information with high reliability is small, of the areas shown in the position information included in the particular information, or a terminal device present in the information deficient area.

26. The method for identifying early status according to claim 23,
wherein, with respect to the collected information registered in the database, the apparatus for identifying early status delivers information to request information collection to a terminal device present in an area in which the amount of information with high reliability is small, of the areas shown in the position information included in the particular information, or a terminal device present in the information deficient area.

27. The method for identifying early status according to claim 18,
wherein, with respect to the information with low reliability registered in the database, the apparatus for identifying early status extracts and compares information added with a classification tag similar to that of the particular information, which has the position information within a certain geographic range as well as high reliability, and
wherein when the content of the extracted and compared information is incorrect, the apparatus for identifying early status delivers information to correct the incorrect information.

28. The method for identifying early status according to claim 17,
wherein the apparatus for identifying early status changes the information collection rule about the collection range and frequency, or the rule information used for classification, display, and analysis, based on the amount of information registered in the database, the added summary, and the added reliability.

29. The method for identifying early status according to claim 17,
wherein the apparatus for identifying early status is connected to a service user terminal and an on-site user terminal to use the functions and information of the apparatus through a network,
wherein the apparatus for identifying early status is also connected to a service provider terminal for proving information to the service user by operating the apparatus,
wherein, upon access from the service user terminal, the apparatus for identifying early status authenticates the user to start the service, based on the registered information,
wherein the apparatus for identifying early status receives requests for collection, classification, analysis, and search from the service user terminal, and provides various screen data based on the collected and classified data, and
wherein the apparatus for identifying early status receives a request from the service user terminal to deliver an instruction to the on-site user terminal, and delivers the instruction information to the on-site user terminal to collect on-site information.

30. An apparatus for identifying early status comprising:
a data collection unit for collecting information on an event that occurred through a network, adding a classification tag from a keyword included in the collected data based on a classification rule, and registering the event that occurred in a collection classification database;
an intelligence deriving unit for monitoring and extracting an event or an area in which the amount of data quickly increases, emerges, or decreases, an area in which the amount of collected data is small or large as compared to population distribution data included in the map data and compared to the hazard map, and an event or area in which the difference in the amount of data is large as compared to data stored for past disasters, based on an analysis rule with respect to the data stored in the collection classification database, and for storing the results in an analysis result database;
an information display unit for mapping the data stored in the collection classification database and the analysis result database, on the map data based on the position information, and for displaying the data through a user interface;
an information delivery unit for converting the data stored in the collection classification database and the analysis result database into a format that can be displayed and used in a user terminal and the like, and for delivering the data to the user terminal and the like; and
a rule management unit for generating a data collection rule, a classification rule describing the relationship between the collected data and the classification tag to be added, and an analysis rule describing the analysis algorithm, based on the input of the user, and for updating the collection rule, the classification rule, and the analysis rule, based on the data stored in the collection classification database and the analysis result database automatically or based on the input of the user.
